(19) United States
(12) Patent Application Publication
(10) Pub. No.: US 2025/0038186 A1
(43) Pub. Date: Jan. 30, 2025

(54) NEGATIVE ELECTRODE ACTIVE MATERIAL AND RECHARGEABLE LITHIUM BATTERY INCLUDING SAME

(71) Applicant: SAMSUNG SDI CO., LTD., Yongin-si (KR)

(72) Inventors: Heeyoung CHU, Yongin-si (KR); Yongseok KIM, Yongin-si (KR); Dae-Hyeok LEE, Yongin-si (KR); Sojeong YU, Yongin-si (KR); Hyejin KIM, Yongin-si (KR); Jaewon KIM, Yongin-si (KR); Youngugk KIM, Yongin-si (KR); Jaehou NAH, Yongin-si (KR)

(21) Appl. No.: 18/613,370

(22) Filed: Mar. 22, 2024

(30) Foreign Application Priority Data
Jul. 14, 2023 (KR) 10-2023-0092006

(51) Int. Cl. H01M 4/38; H01M 4/02; H01M 4/36; H01M 4/583

(52) U.S. Cl. CPC H01M 4/386; H01M 4/366; H01M 4/583; H01M 2004/021; H01M 2004/027

(57) ABSTRACT

A negative electrode active material and a rechargeable lithium battery that includes the negative electrode active material, the negative electrode active material includes porous silicon secondary particles in which boron-doped silicon primary particles are agglomerated; and amorphous carbon and the rechargeable lithium battery includes a negative electrode including the negative electrode active material, a positive electrode and an electrolyte.

### CROSS-REFERENCE TO RELATED APPLICATION

This application claims priority to and the benefit of Korean Patent Application No. 10-2023-0092006 filed in the Korean Intellectual Property Office on Jul. 14, 2023, the entire contents of which are incorporated herein by reference.

### BACKGROUND

### 1. Field

Embodiments relate to negative electrode active materials and rechargeable lithium batteries including the same.

### 2. Description of the Related Art

Recently, with the rapid spread of electronic devices that use batteries, such as mobile phones, laptop computers, and electric vehicles, a demand for small, lightweight, and relatively high-capacity rechargeable lithium batteries is rapidly increasing.

In addition, the development of high-energy density batteries has recently been considered, and for this purpose, high-capacity negative electrode active materials may be used.

Attempts are being made to use Si-based negative electrode active materials as such high-capacity negative electrode active materials.

### SUMMARY

The embodiments may be realized by providing a negative electrode active material including porous silicon secondary particles in which boron-doped silicon primary particles are agglomerated; and amorphous carbon.

An amount of boron in the negative electrode active material may be about 0.01 wt % to about 5 wt %, based on a total weight of the negative electrode active material.

The amorphous carbon may be between the boron-doped silicon primary particles or on a surface of the porous silicon secondary particles.

A pore volume of the porous silicon secondary particles may be about 0.001 cm³/g to about 0.01 cm³/g.

The negative electrode active material may further include a boron material.

The boron material may include boron oxide, boric acid, MgB₂, boron, or a combination thereof.

The boron material may include boron oxide, boric acid, boron, or a combination thereof.

The boron material may be on a surface of the boron-doped silicon primary particles or on a surface of the porous silicon secondary particles.

The amorphous carbon may include soft carbon, hard carbon, a mesophase pitch carbonized product, sintered coke, or a combination thereof.

An average particle diameter (D50) of the boron-doped silicon primary particles may be about 10 nm to about 500 nm.

An average particle diameter (D50) of the porous silicon secondary particles may be about 5 μm to about 12 μm.

The amorphous carbon may be in the form of a coating layer, and a thickness of the amorphous carbon coating layer may be about 1 nm to about 2 μm.

The embodiments may be realized by providing a rechargeable lithium battery including a negative electrode including the negative electrode active material according to an embodiment, a positive electrode, and an electrolyte.

### BRIEF DESCRIPTION OF THE DRAWINGS

Features will be apparent to those of skill in the art by describing in detail exemplary embodiments with reference to the attached drawings in which:

FIG. 1 is schematic view showing a rechargeable lithium battery according to some embodiments.

FIG. 2 is an image of the negative electrode active material prepared according to Example 1 prepared using secondary ion mass spectroscopy (SIMS) (a: silicon element mapping analysis results, b: boron element mapping analysis results).

FIG. 3 is a graph showing the results of internal XPS (X-ray photoelectron spectroscopy) analysis of the negative electrode active material prepared according to Examples 1 and 2 and Comparative Example 1.

FIG. 4 is a graph showing the measured X-ray diffraction peak intensities of the negative electrode active materials prepared according to Examples 1 and 2 and Comparative Example 1.

FIG. 5 is a graph showing room temperature cycle-life characteristics of rechargeable lithium battery cells manufactured according to Examples 3 to 5 and Comparative Examples 1 and 2.

### DETAILED DESCRIPTION

Hereinafter, embodiments will be described in detail. However, these embodiments are presented as an example, and the present disclosure is not limited thereto, and the present disclosure is defined by the scope of the claims described below.

The terminology used herein is used to describe embodiments only, and is not intended to limit the present disclosure. The singular expression includes the plural expression unless the context clearly dictates otherwise.

As used herein, “combination thereof” refers to a mixture, a laminate, a composite, a copolymer, an alloy, a blend, a reaction product, and the like of constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout the specification. It will be understood that when an element such as a layer, film, region, or substrate is referred to as being “on” another element, it may be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

Herein, “or” is not to be construed as an exclusive meaning, for example, “A or B” is construed to include A, B, A+B, and the like.

As used herein, when a definition is not otherwise provided, a particle diameter or size may be an average particle diameter. This average particle diameter means the average particle diameter (D50), which means a diameter (D50) of particles having a cumulative volume of 50 volume % in a particle size distribution. The average particle diameter may be measured by a method well known to those skilled in the art, for example, may be measured by a particle size analyzer, or may be measured by a transmission electron microscopic photograph or a scanning electron microscopic photograph. Alternatively, it is possible to obtain an average particle diameter value by measuring it using a dynamic light-scattering method, performing data analysis, counting the number of particles for each particle size range, and calculating from this.

A negative electrode active material according to some embodiments includes porous silicon secondary particles in which boron-doped silicon primary particles are agglomerated; and amorphous carbon. The negative electrode active material according to some embodiments may be used for rechargeable lithium batteries.

In an implementation, the boron-doped silicon primary particles mean that boron is substituted in the crystal structure of silicon, and boron is located between the silicon lattices.

The porous silicon secondary particles may be secondary particles including pores made by agglomerating boron-doped silicon primary particles.

The porous silicon secondary particles may be formed by agglomerating silicon primary particles and include pores therein. Silicon may expand in volume during charging and discharging. In an implementation, the porous silicon secondary particles according to some embodiments may include pores inside, they may have a buffer function capable of absorbing the volume expanded by the pore, and may effectively suppress the expansion of the entire volume of the negative electrode active material.

A pore volume of the porous silicon secondary particles may be, e.g., about 0.001 cm³/g to about 0.01 cm³/g, or about 0.002 cm³/g to about 0.007 cm³/g. Maintaining the pore volume of the porous silicon secondary particles within the above ranges may help ensure that the porous silicon secondary particles include micro pores, an expansion reduction effect may be further increased, and during charging and discharging, a structure of the negative electrode active material may be maintained better, and effects of low expansion and long cycle-life may be increased.

An average particle diameter (D50) of the silicon primary particles may be, e.g., about 10 nm to about 500 nm, or about 20 nm to about 150 nm. In an implementation, the secondary particles may have a particle size of about 5 μm to about 12 μm. A particle diameter of the secondary particles may be, e.g., about 6 μm to about 12 μm or about 6 μm to about 10 μm.

Porous silicon secondary particles have low conductivity due to their porous structure, and the negative electrode active material according to some embodiments includes boron, e.g., boron may be doped into the silicon primary particles, which may help improve conductivity and thus improve battery characteristics such as efficiency, capacity, and cycle-life.

In an implementation, boron may be included in the negative electrode active material in an amount of, e.g., about 0.01 wt % to about 5 wt %, about 0.05 wt % to about 2 wt %, or about 0.05 wt % to about 1 wt %, based on a total weight of the negative electrode active material. In an implementation, the amount of boron may refer to a total boron amount included in the negative electrode active material. Maintaining the amount of boron within the above ranges may help ensure that the conductivity of the negative electrode active material may be further improved.

In an implementation, the negative electrode active material according to some embodiments may further include a (e.g., another) boron material.

In an implementation, the boron material may include, e.g., boron oxide, boric acid, MgB₂, boron, or a combination thereof. In an implementation, the boron material may include, e.g., boron oxide, boric acid, boron, or a combination thereof. Among the boron materials, boron may be boron that is not doped in silicon primary particles and exists separately from silicon primary particles or secondary particles, e.g., elemental boron.

Accordingly, the total amount of boron included in the negative electrode active material according to some embodiments may be within the above ranges, and it is appropriate and there is no need to define an amount of doped boron and an amount of boron included in the boron material. The total amount of boron refers to a sum of the boron amount doped in the silicon primary particles and the amount of boron included in the boron material on the surface of the silicon primary particles or silicon secondary particles. In other words, it means the total amount of boron present in the negative electrode active material.

In the negative electrode active material according to some embodiments, boron may be doped into the silicon primary particles and may be on the surface of the porous silicon secondary particles, which may be confirmed through a mapping experiment on the negative electrode active material. The fact that silicon primary particles are doped with boron may be measured through an XPS experiment.

In the negative electrode active material according to some embodiments, the amorphous carbon may be between the silicon primary particles or on the surface of the silicon secondary particles. In the negative electrode active material according to some embodiments, the amorphous carbon may be on the porous silicon secondary particles and, e.g., may be included as a coating layer covering the secondary particles. In an implementation, the amorphous carbon may be between the primary particles, e.g., within pores of porous silicon secondary particles.

In an implementation, the amorphous carbon may include, e.g., soft carbon, hard carbon, a mesophase pitch carbonized product, sintered coke, or a combination thereof.

In an implementation, the amorphous carbon may exist as a coating layer, and a thickness thereof may be, e.g., about 1 nm to about 2 μm, about 1 nm to about 500 nm, about 10 nm to about 300 nm, or about 20 nm to about 200 nm. Maintaining the thickness of the amorphous carbon coating layer within the above ranges may help ensure that silicon volume expansion may be well suppressed during charging and discharging.

In the negative electrode active material according to some embodiments, a mixing (e.g., weight) ratio of the silicon and the amorphous carbon may be, e.g., about 55:45 to about 70:30, or about 55:45 to about 65:35.

In an implementation, the negative electrode active material according to some embodiments may further include the boron material, and the boron material may also be covered with the amorphous carbon coating layer.

The negative electrode active material according to this embodiment may be prepared using the boron material. Addition of the boron material may be performed in any process during the negative electrode active material preparing process, before the heat treatment process.

In an implementation, the boron material may be used in a porous silicon preparing process or in a mixing process with an amorphous carbon precursor. Hereinafter, a preparing method using the boron material will be described.

### 1) Used in Porous Silicon Preparing Process

Micrometer-sized silicon particles and an organic solvent may be mixed to prepare a silicon dispersion. The mixing process may be performed as a milling process to reduce the size of the silicon particles from micrometers to nanometers to become silicon nanoparticles (primary particles). The milling process may be performed with a bead mill or a ball mill.

As the organic solvent, alcohols that do not oxidize the silicon particles and are easily volatilized may be appropriately used, and the alcohols may include, e.g., isopropyl alcohol, ethanol, methanol, butanol, propylene glycol, or a combination thereof.

An average particle diameter (D50) of the silicon nanoparticles may be, e.g., about 10 nm to about 500 nm, or about 20 nm to about 150 nm. The maximum particle diameter (Dmax) of the silicon nanoparticles may be less than or equal to about 1,000 nm. Maintaining the average particle diameter (D50) of silicon nanoparticles within the above ranges may help ensure that volume expansion (which could otherwise occur during charging and discharging) may be suppressed, and disconnection of the conductive path due to particle crushing during charging and discharging may be prevented.

A mixing ratio of the silicon primary particles and the organic solvent may be, e.g., about 5:95 to about 30:70 by weight, or about 10:90 to about 25:75 by weight. Maintaining the mixing ratio of the silicon primary particles and the organic solvent within the above ranges may help ensure that there may be an advantage of maximizing milling efficiency.

The boron material may be added to the obtained silicon dispersion, and the mixture may be spray-dried to produce porous silicon secondary particles. The boron material may be the same as described above. According to the spray drying process, primary particles, which are silicon nanoparticles, may be agglomerated to form secondary particles, and boron oxide may also be agglomerated in this process. The secondary particles may be spherical and have an average particle diameter (D50) of about 5 μm to about 12 μm.

An amount of the boron material may be adjusted to an amount sufficient for boron to be doped into the silicon primary particles. In an implementation, it may be about 0.2 wt % to about 11 wt %, based on a total weight of the silicon nanoparticles. Maintaining the amount of the boron material within the above range may help ensure that conductivity may be further improved while maintaining capacity and efficiency due to low formation of by-products (undecomposed residues).

The spray drying process may be performed at about 50° C. to about 200° C. Carrying out the spray drying temperature within the above temperature may help ensure that primary particle agglomeration may occur effectively and sufficiently.

The pore volume of the porous silicon secondary particles may be about 0.001 cm³/g to about 0.01 cm³/g, e.g., about 0.002 cm³/g to about 0.007 cm³/g. Maintaining the pore volume of the porous silicon secondary particles within the above ranges may help ensure that the porous silicon secondary particles include micro pores, an expansion reduction effect may be further increased, and during charging and discharging, a structure of the negative electrode active material may be better maintained, and effects of low expansion and long cycle-life may be increased.

The porous silicon secondary particles prepared through the above process and the amorphous carbon precursor may be mixed to prepare a mixture.

The amorphous carbon precursor may include, e.g., a phenol resin, a furan resin, an epoxy resin, polyacrylonitrile, a polyamide resin, a polyimide resin, a polyamide-imide resin, synthetic pitch, petroleum pitch, coal pitch, meso pitch, tar, or a combination thereof.

A mixing ratio of the porous silicon secondary particles and the amorphous carbon precursor may be adjusted so that a mixing ratio of silicon and amorphous carbon in the final product may be, e.g., about 55:45 to about 70:30, or about 55:45 to about 65:35.

Subsequently, the obtained mixture may be heat treated to obtain a heat treatment product. This heat treatment process may be performed at about 700° C. to about 1,000° C., e.g., about 800° C. to about 1000° C. The heat treatment process may be performed for, e.g., about 1 hour to about 10 hours, about 1 hour to about 8 hours, or about 1 hour to about 6 hours.

In an implementation, the heat treatment process may be performed under N₂ or Ar atmosphere.

According to the heat treatment process, the amorphous carbon precursor may form amorphous carbon to form an amorphous carbon coating layer. According to the heat treatment process, the boron material may be decomposed to form boron, and this boron may be doped into the silicon primary particles, e.g., the boron in the crystal structure of silicon may be substituted, and the boron may be located between or in the silicon lattice. The decomposed boron may remain without being doped into the silicon primary particles, and may be located on the surface of the silicon primary particles or the surface of the silicon secondary particles. The boron materials may not all be decomposed, and some may remain in an undecomposed state. These undecomposed boron materials may be on the surface of the silicon primary particles or the surface of the silicon secondary particles. The decomposed boron or undecomposed boron materials may be located continuously in layers on the surface of the silicon primary particles or the surface of the silicon secondary particles, or may be discontinuously located in the form of an island thereon.

2) Used in Mixing Process with Amorphous Carbon Precursor

First, porous silicon secondary particles including pores inside may be manufactured.

The porous silicon secondary particles may include silicon nanoparticles, e.g., silicon primary particles that are agglomerated. An average particle diameter (D50) of the silicon nanoparticles may be, e.g., about 10 nm to about 500 nm, or about 20 nm to about 150 nm. The maximum particle diameter (Dmax) of the silicon nanoparticles may be less than or equal to about 1,000 nm. Maintaining the average particle diameter (D50) of silicon nanoparticles within the above ranges may help ensure that volume expansion (which could occur during charging and discharging) may be suppressed, and disconnection of the conductive path due to particle crushing during charging and discharging may be prevented. The agglomerating process of the silicon nanoparticles may be performed as follows. A silicon dispersion may be prepared by mixing micrometer-sized silicon particles with an organic solvent. At this time, the mixing process may be performed as a milling process to reduce the size of the silicon particles from micrometers to nanometers to become silicon nanoparticles. The milling process may be performed with a bead mill or a ball mill.

As the organic solvent, alcohols that do not oxidize the silicon particles and are easily volatilized may be appropriately used, and the alcohols may include, e.g., isopropyl alcohol, ethanol, methanol, butanol, propylene glycol, or a combination thereof.

A mixing ratio of the silicon primary particles and the organic solvent may be, e.g., about 5:95 to about 30:70 by weight, and about 10:90 to about 25:75 by weight. Maintaining the mixing ratio of the silicon primary particles and the organic solvent within the above ranges may help ensure that there may be an advantage of maximizing milling efficiency.

The obtained silicon dispersion may be spray dried to produce porous silicon secondary particles. This spray drying process may be carried out at about 50° C. to about 200° C. According to this spray drying process, primary particles, which are silicon nanoparticles, may be agglomerated to form secondary particles, thereby producing porous silicon secondary particles. Performing the spray drying process within the above temperature range may help ensure that the process in which primary particles are agglomerated to form secondary particles may be performed more appropriately.

The pore volume of the porous silicon secondary particles may be, e.g., about 0.001 cm³/g to about 0.01 cm³/g, and may be about 0.002 cm³/g to about 0.007 cm³/g. Maintaining the pore volume of the porous silicon secondary particles within the above ranges may help ensure that the porous silicon secondary particles include micro pores, an expansion reduction effect may be further increased, and during charging and discharging, a structure of the negative electrode active material may be maintained better, and effects of low expansion and long cycle-life may be increased.

A porous silicon secondary particle including pores therein, an amorphous carbon precursor, and a boron material may be mixed to prepare a mixture. The boron material may be the same as described above.

The amorphous carbon precursor may be as described above.

The mixing (e.g., weight) ratio of the porous silicon secondary particles and the boron material may be, e.g., about 99.8:0.2 to about 90:10, about 99.8: about 0.2 to 98:2, or about 98:2 to about 96:4.

Maintaining the mixing ratio of the porous silicon secondary particles and the boron material within the above ranges may help ensure that the formation of by-products (undecomposed residues) is small, thereby maintaining capacity and efficiency, and further improving conductivity.

In an implementation, the mixing ratio of the porous silicon secondary particles and the amorphous carbon precursor may be, e.g., about 55:45 to about 70:30, or about 55:45 to about 65:45.

Subsequently, the obtained mixture may be heat treated to obtain a heat treatment product. This heat treatment process may be performed at about 700° C. to about 1,000° C., e.g., about 800° C. to about 1,000° C. The heat treatment process may be performed for, e.g., about 1 hour to about 6 hours, about 2 hours to about 6 hours, or about 4 hours to about 6 hours.

In an implementation, heat treatment process may be performed under a N₂ or Ar atmosphere.

According to the heat treatment process, the amorphous carbon precursor may form amorphous carbon to form an amorphous carbon coating layer. According to the heat treatment process, the boron material may be decomposed to form boron, and this boron may be doped into the silicon primary particles, e.g., located between or within the silicon lattice. The decomposed boron may also remain without being doped into the silicon primary particles, and may be located on the surface of the silicon primary particles or the surface of the silicon secondary particles. In an implementation, the boron materials may not all be decomposed, and some may remain in an undecomposed state. These undecomposed boron materials may be located on the surface of the silicon primary particles or the surface of the silicon secondary particles. These decomposed boron or undecomposed boron materials may be located continuously in layers on the surface of the silicon primary particles and/or the surface of the silicon secondary particles, or may be discontinuously located in the form of an island thereon.

Some embodiments provide a rechargeable lithium battery including a negative electrode, a positive electrode, and an electrolyte.

The negative electrode may include a current collector and a negative electrode active material layer on the current collector and including the negative electrode active material according to some embodiments.

The negative electrode active material according to some embodiments may be included as a first negative electrode active material, and crystalline carbon may be included as a second negative electrode active material. In this case, a mixing ratio of the first negative electrode active material and the second negative electrode active material may be in a weight ratio of about 1:99 to about 50:50. In an implementation, the negative electrode active material may include the first negative electrode active material and the second negative electrode active material in a weight ratio of about 5:95 to about 20:80.

In the negative electrode active material layer, an amount of the negative electrode active material may be about 95 wt % to about 98 wt %, based on a total weight of the negative electrode active material layer.

The negative electrode active material layer may include a binder and may further include a conductive material. An amount of the binder may be about 0.1 wt % to about 5 wt % based on a total weight of the negative electrode active material layer. An amount of the conductive material may be, e.g., about 0.01 wt % to about 5 wt % based on 100 wt % of the negative electrode active material layer.

The binder may serve to well attach the negative electrode active material particles to each other and also to well attach the negative electrode active material to the current collector. The binder may be a non-aqueous binder, an aqueous binder, or a combination thereof.

The non-aqueous binder may include an ethylenepropylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The aqueous binder may include a styrene-butadiene rubber (SBR), an acrylated styrene-butadiene rubber (ABR), an acrylonitrile-butadiene rubber, an acrylic rubber, a butyl rubber, a fluororubber, an ethylene oxide-containing polymer, polyvinyl pyrrolidone, polypropylene, polyepicrohydrin, polyphosphazene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

A cellulose compound may be used as the negative electrode binder, or a mixture of the cellulose compound and the aqueous binder may be used. The cellulose compound may include, e.g., carboxymethyl cellulose, hydroxypropylmethyl cellulose, methyl cellulose, or alkali metal salts thereof. The alkali metal may be Na, K, or Li. The cellulose compound may act as a binder and also as a thickener that is capable of increasing viscosity. In an implementation, the amount of the cellulose-based compound used may be about 0.1 to about 3 parts by weight, based on 100 parts by weight of the negative electrode active material.

The conductive material may impart conductivity to the electrode, and a suitable material may be used as long as it does not cause chemical change in the battery to be configured and is an electron conductive material. Examples of the conductive material may include a carbon material such as natural graphite, artificial graphite, carbon black, acetylene black, Ketjen black, a carbon fiber, or the like; a metal material of a metal powder or a metal fiber including copper, nickel, aluminum, silver, and the like; a conductive polymer such as a polyphenylene derivative; or a mixture thereof.

The current collector may include a copper foil, a nickel foil, a stainless steel foil, a titanium foil, a nickel foam, a copper foam, a polymer substrate coated with a conductive metal, or a combination thereof.

The positive electrode may include a positive current collector and a positive electrode active material layer formed on the positive current collector.

The positive electrode active material may include lithiated intercalation compounds that reversibly intercalate and deintercalate lithium ions. In an implementation, one or more composite oxides of a metal, e.g., cobalt, manganese, nickel, or a combination thereof, and lithium may be used. In an implementation, a compound represented by any one of the following chemical formulas may be used. LiₐA_{1-b}X_{b}D¹₂ (0.90≤a≤1.8, 0≤b≤0.5); LiₐA_{1-b}X₆O_{2-c1}D¹_{c1} (0.90≤a≤1.8, 0≤b≤0.5, 0≤c1≤0.05); LiₐE_{1-b}X₆O_{2-c1}D¹_{c1} (0.90≤a≤1.8, 0≤b≤0.5, 0≤c1≤0.05); LiₐE₂₋₆X₆O_{4-c1}D¹_{c1} (0.90≤a≤1.8, 0≤b≤0.5, 0≤c1≤0.05); LiₐNi_{1-b-c}CO_{b}X_{c}D¹_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤≤≤0.5, 0<α<2); LiₐNi_{1-b-c}CO_{b}X_{c}O_{2-α}T₂ (0.90≤a≤1.8, 0≤b≤0.5, 0≤c≤0.5, 0<α<2); LiₐNi_{1-b-c}Mn_{b}X_{c}D¹_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8).

In the above chemical formulas, A may be, e.g., Ni, Co, Mn, or a combination thereof; X may be, e.g., Al, Ni, Co, Mn, Cr, Fe, Mg, Sr, V, a rare earth element, or a combination thereof; D1 may be, e.g., O, F, S, P, or a combination thereof; E may be, e.g., Co, Mn, or a combination thereof; T may be, e.g., F, S, P, or a combination thereof; G may be, e.g., Al, Cr, Mn, Fe, Mg, La, Ce, Sr, V, or a combination thereof; Q may be, e.g., Ti, Mo, Mn, or a combination thereof; Z may be, e.g., Cr, V, Fe, Sc, Y, or a combination thereof; J may be, e.g., V, Cr, Mn, Co, Ni, Cu, or a combination thereof; and L¹ may be, e.g., Mn, Al or a combination thereof.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound. In an implementation, the method may include a suitable coating method (e.g., spray coating, dipping, etc.).

In the positive electrode, an amount of the positive electrode active material may be about 90 wt % to about 98 wt %, based on a total weight of the positive electrode active material layer.

In an implementation, the positive electrode active material layer may further include a binder and a conductive material. In an implementation, the amounts of the binder and the conductive material may each be about 1 wt % to about 5 wt %, respectively, based on a total weight of the positive electrode active material layer.

The binder may serve to well attach the positive electrode active material particles to each other and also to well attach the positive electrode active material to the current collector. Examples thereof may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

The conductive material may impart conductivity to the electrode, and a suitable material may be used as long as it does not cause chemical change in the battery to be configured and is an electron conductive material. Examples of the conductive material may include a carbon material such as natural graphite, artificial graphite, carbon black, acetylene black, Ketjen black, a carbon fiber, or the like; a metal material of a metal powder or a metal fiber including copper, nickel, aluminum, silver, and the like; a conductive polymer such as a polyphenylene derivative; or a mixture thereof.

The current collector may include Al.

The electrolyte may include a non-aqueous organic solvent and a lithium salt.

The non-aqueous organic solvent may serve as a medium for transmitting ions taking part in the electrochemical reaction of a battery.

The non-aqueous organic solvent may include a carbonate, ester, ether, ketone, alcohol, or aprotic solvent.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like, and the ester solvent may include methyl acetate, ethyl acetate, n-propyl acetate, dimethylacetate, methylpropionate, ethylpropionate, propyl propionate, γ-butyrolactone, decanolide, valerolactone, mevalonolactone, caprolactone, or the like. The ether solvent may include dibutyl ether, tetraglyme, diglyme, dimethoxyethane, 2-methyltetrahydrofuran, 2,5-dimethyltetrahydrofuran, tetrahydrofuran, or the like, and the ketone solvent may include cyclohexanone or the like. The alcohol solvent may include ethanol, isopropyl alcohol, or the like and the aprotic solvent may include nitriles such as R—CN (where R is a C2 to C20 linear, branched, or cyclic hydrocarbon, a double bond, an aromatic ring, or an ether bond), amides such as dimethylformamide, dioxolanes such as 1,3-dioxolane, 1,4-dioxolane, sulfolanes, or the like.

The organic solvents may be used alone or in combination with one or more, and the mixing ratio if used in combination with one or more may be appropriately adjusted according to the desired battery performance, which may be widely understood by those skilled in the art.

In an implementation, a mixture of the above non-aqueous organic solvents may be used, e.g., a mixed solvent of cyclic carbonate and chain carbonate, a mixed solvent of cyclic carbonate and propionate solvent, or a mixed solvent of cyclic carbonate, chain carbonate, and propionate solvent. The propionate solvent may include, e.g., methyl propionate, ethyl propionate, propyl propionate, or a combination thereof.

In an implementation, a mixture of cyclic carbonate and chain carbonate or cyclic carbonate and propionate solvent may be used, and it may be appropriate in terms of the performance of the electrolyte that they are mixed at a volume ratio of about 1:1 to about 1:9. If using a mixture of cyclic carbonate, chain carbonate, and propionate solvents, they may be mixed in a volume ratio of about 1:1:1 to about 3:3:4. In an implementation, a mixing ratio of the solvents may be appropriately adjusted depending on the desired physical properties.

The organic solvent may further include an aromatic hydrocarbon organic solvent in addition to the carbonate solvent. The carbonate solvent and the aromatic hydrocarbon organic solvent may be mixed in a volume ratio of about 1:1 to about 30:1.

The aromatic hydrocarbon organic solvent may be an aromatic hydrocarbon compound of Chemical Formula 1.

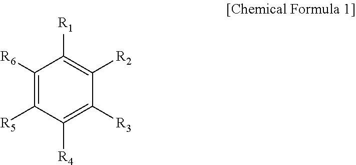

In Chemical Formula 1, R₁ to R₆ may each independently be or include, e.g., hydrogen, a halogen, a C1 to C10 alkyl group, a haloalkyl group, or a combination thereof.

Examples of the aromatic hydrocarbon organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

In an implementation, the electrolyte may further include an additive of vinylethyl carbonate, vinylene carbonate, or an ethylene carbonate compound of Chemical Formula 2 in order to improve a cycle-life of a battery as an additive.

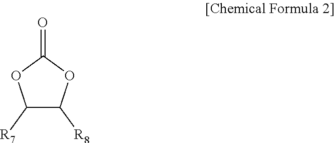

In Chemical Formula 2, R₇ and R₈ may each independently be or include, e.g., hydrogen, a halogen, a cyano group (CN), a nitro group (NO₂), and a fluorinated C1 to C5 alkyl group, provided that at least one of R₇ and R₈ is a halogen, a cyano group (CN), a nitro group (NO₂), or a fluorinated C1 to C5 alkyl group, and R₇ and R₈ are not hydrogen.

Examples of the ethylene carbonate compound may include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving a cycle-life may be used within an appropriate range.

The lithium salt dissolved in an organic solvent may supply a battery with lithium ions, may basically operate the rechargeable lithium battery, and may help improve transportation of the lithium ions between positive and negative electrodes. Examples of the lithium salt may include LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CxF₂ₓ₊₁SO₂)(CyF_{2y+1}SO₂), wherein, x and y are natural numbers, for example an integer ranging from 1 to 20, lithium difluoro (bisoxolato) phosphate, LiCl, LiI, LiB(C₂O₄)₂ (lithium bis(oxalato) borate: LiBOB), and lithium difluoro (oxalato) borate (LiDFOB). A concentration of the lithium salt may range from about 0.1 M to about 2.0 M. Including the lithium salt at the above concentration range may help ensure that an electrolyte may have excellent performance and lithium ion mobility due to optimal electrolyte conductivity and viscosity.

The rechargeable lithium battery may further include a separator between the negative electrode and the positive electrode, depending on a type of the battery. Examples of a suitable separator material include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The separator may include a porous substrate and a coating layer including an organic material, an inorganic material, or a combination thereof on one or both surfaces of the porous substrate.

The porous substrate may be a polymer film formed of polymers of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness of about 1 μm to about 40 μm, e.g., about 1 μm to about 30 μm, about 1 μm to about 20 μm, about 5 μm to about 15 μm, or about 10 μm to about 15 μm.

The organic material may include a (meth)acryl copolymer including a first structural unit derived from (meth)acrylamide, and a second structural unit including a structural unit derived from (meth)acrylic acid or (meth)acrylate, and a structural unit derived from (meth)acrylamidosulfonic acid or a salt thereof.

The inorganic material may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof. An average particle diameter (D50) of the inorganic particles may be about 1 nm to about 2,000 nm, e.g., about 100 nm to about 1000 nm, or about 100 nm to about 700 nm.

The organic material and the inorganic material may be mixed in one coating layer, or a coating layer including an organic material and a coating layer including an inorganic material may be stacked.

A thickness of the coating layer may be each about 0.5 μm to about 20 μm, e.g., about 1 μm to about 10 μm, or about 1 μm to about 5 μm.

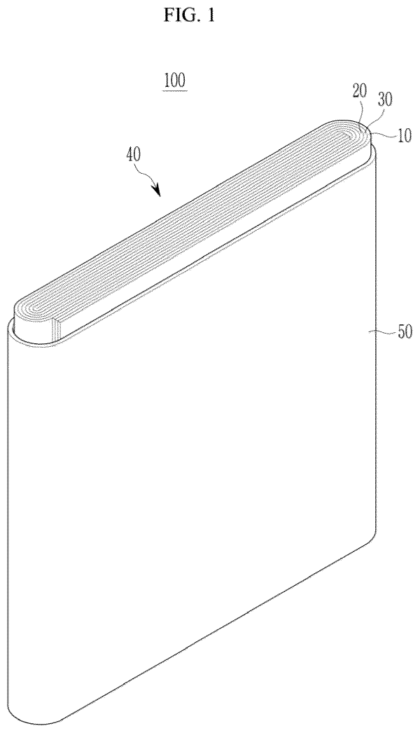

FIG. 1 is an exploded perspective view of a rechargeable lithium battery according to some embodiments. In an implementation, as illustrated in the drawing, the rechargeable lithium battery may be a prismatic battery, or may include variously-shaped batteries such as a cylindrical battery, a pouch battery, or the like.

Referring to FIG. 1, a rechargeable lithium battery 100 according to some embodiments may include an electrode assembly 40 manufactured by winding a separator 30 between a positive electrode 10 and a negative electrode 20, and a case 50 housing the electrode assembly 40. An electrolyte may be impregnated in the positive electrode 10, the negative electrode 20, and the separator 30.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

An ethanol solvent and silicon particles having a particle size of several micrometers were mixed in a weight ratio of 85:15, and a silicon nano-dispersion was prepared using a bead mill (Netzsch, Germany). In the prepared silicon nano-dispersion, the average particle diameter (D50) of silicon nanoparticles (primary particles) was 90 nm, and the maximum particle diameter (Dmax) was 150 nm.

The silicon nano-dispersion was spray dried at 180° C. using a spray dryer to prepare porous silicon secondary particles. The prepared porous silicon secondary particles were formed by agglomerating primary particles, which were silicon nanoparticles, into spherical secondary particles with an average particle diameter (D50) of 8 μm and a pore volume of 0.007 cm³/g.

The obtained porous silicon secondary particles, petroleum pitch, and boron oxide (B₂O₃) were mixed to prepare a mixture. Herein, the (porous silicon secondary particles and petroleum pitch): the boron oxide had a weight ratio of 98:2, and the porous silicon secondary particles: the petroleum pitch had a weight ratio of 63.3:36.7.

The mixture was heat-treated at 950° C. under an N₂ atmosphere for 2 hours to prepare a negative electrode active material as a heat treatment product.

According to the heat treatment process, the boron oxide was decomposed, so that boron was doped inside the silicon primary particles, and the petroleum pitch was converted into soft carbon, so that the soft carbon was positioned inside pores of the porous silicon secondary particles, and a soft carbon coating layer was formed on the porous silicon secondary particle surface.

An amount of boron included in the negative electrode active material was 0.7 wt %, based on a total weight of the total negative electrode active material. The soft carbon coating layer had a thickness of 200 nm.

An amount of silicon constituting the porous silicon secondary particles was 62.9 wt %, and an amount of the soft carbon amorphous carbon was 36.4 wt %, based on the total weight of the total negative electrode active material.

97.5 wt % of the prepared negative electrode active material, 1.5 wt % of carboxymethyl cellulose, and 1 wt % of a styrene butadiene rubber were mixed in a water solvent, preparing negative electrode active material layer slurry.

The negative electrode active material layer slurry was coated on a Cu foil current collector and then, dried and compressed, forming a negative electrode active material layer and thereby manufacturing a negative electrode.

The negative electrode was used with a lithium metal counter electrode and an electrolyte for a half-cell to manufacture a half-cell. The electrolyte for a half-cell was prepared by mixing ethylene carbonate, ethylmethyl carbonate, and dimethyl carbonate (in a volume ratio of 2:1:7), adding LiPF₆ to the mixed solvent to prepare a 1.5 M electrolyte precursor, and adding fluoroethylene carbonate thereto. An amount of the fluoroethylene carbonate was 10 wt %, based on a total weight of the electrolyte precursor.

The negative electrode was also used with a LiNi_{0.88}Co_{0.1}Al_{0.1}O₂ positive electrode and an electrolyte for a full cell to fabricate a rechargeable lithium battery cell as a full cell. The electrolyte for a full cell was prepared by mixing ethylene carbonate, ethylmethyl carbonate, dimethyl carbonate (in a volume ratio of 2:1:7), adding LiPF₆ to the mixed solvent to prepare a 1.5 M electrolyte precursor, and adding fluoroethylene carbonate thereto. An amount of the fluoroethylene carbonate was 3.5 wt %, based on a total weight of the electrolyte precursor.

### Example 2

A negative electrode active material was prepared in the same manner as in Example 1 except that the weight ratio of (porous silicon secondary particles and petroleum pitch):boron oxide was 96:4, and the weight ratio of porous silicon secondary particles:petroleum pitch was 63.3:36.7.

The prepared negative electrode active material included porous silicon secondary particles in which boron-doped silicon primary particles were agglomerated, soft carbon inside pores of the porous silicon secondary particles, and a soft carbon coating layer on the porous silicon secondary particle surface.

An amount of boron included in the negative electrode active material was 1.4 wt %, based on a total weight of the negative electrode active material. The soft carbon coating layer had a thickness of 200 nm.

An amount of silicon constituting the porous silicon secondary particles was 62.4 wt %, based on a total weight of the negative electrode active material, and an amount of the soft carbon amorphous carbon was 36.2 wt %.

The negative electrode active material was used to manufacture a negative electrode, and this negative electrode was used with a lithium metal counter electrode, and the electrolyte for a full-cell according to Example 1 to fabricate a half-cell.

The negative electrode was also used with a LiNi_{0.88}Co_{0.1}Al_{0.1}O₂ positive electrode and the electrolyte for a full-cell of Example 1 to fabricate a rechargeable lithium battery cell.

### Example 3

An ethanol solvent and silicon particles having a particle size of several micrometers were mixed in a weight ratio of 85:15 and then, treated with a bead mill (Netzsch, Germany) to obtain silicon nano-dispersion. In the prepared silicon nano-dispersion, the silicon nanoparticles (primary particles) had an average particle diameter (D50) of 90 nm and a maximum particle diameter (Dmax) of 150 nm.

After adding boron oxide (B₂O₃) to the silicon nano-dispersion, this mixture was spray-dried at 180° C. by using a spray drier to prepare porous silicon secondary particles. An amount of the boron oxide was 2 wt %, based on a total weight of the silicon nanoparticles. The prepared porous silicon secondary particles were formed by agglomerating primary particles, which were silicon nanoparticles, into spherical secondary particles having an average particle diameter (D50) of 8 μm and a pore volume of 0.007 cm³/g.

The obtained porous silicon secondary particles were mixed with petroleum pitch, and this mixture was heat-treated at 950° C. for 2 hours under an N₂ atmosphere to prepare a negative electrode active material as a heat treatment product. In the mixing process, the porous silicon secondary particles and the petroleum pitch were used to include silicon and petroleum pitch in a weight ratio of 63.3:36.7.

According to the heat treatment process, the boron oxide was decomposed, so that boron was doped inside the silicon primary particles, and the petroleum pitch formed a soft carbon coating layer on the porous silicon secondary particle surface.

Accordingly, the prepared negative electrode active material included the porous silicon secondary particles in which boron-doped silicon primary particles were agglomerated, soft carbon inside pores of the porous silicon secondary particles, and a soft carbon coating layer on the porous silicon secondary particle surface.

An amount of boron included in the negative electrode active material was 0.7 wt %, based on a total weight of the negative electrode active material. The soft carbon coating layer had a thickness of 200 nm.

An amount of silicon constituting the porous silicon secondary particles was 62.9 wt %, based on a total weight of the negative electrode active material, and an amount of the soft carbon amorphous carbon was 36.4 wt %.

The negative electrode active material was used to manufacture a negative electrode, and this negative electrode was used with a lithium metal counter electrode and the electrolyte for a half-cell according to Example 1 to fabricate a half-cell.

The negative electrode was also used with a LiNi_{0.88}Co_{0.1}Al_{0.1}O₂ positive electrode and the electrolyte for a full-cell of Example 1 to fabricate a rechargeable lithium battery cell as a full-cell.

### Example 4

A negative electrode active material was prepared in the same manner as in Example 3 except that the boron oxide was used in an amount of 4 wt %, based on a total weight of the silicon nanoparticles.

The prepared negative electrode active material included the porous silicon secondary particles in which boron-doped silicon primary particles were agglomerated, soft carbon positioned inside pores of the porous silicon secondary particles, and a soft carbon coating layer on the porous silicon secondary particle surface.

An amount of boron included in the negative electrode active material was 1.4 wt %, based on a total weight of the negative electrode active material. The soft carbon coating layer had a thickness of 200 nm.

An amount of silicon constituting the porous silicon was 62.4 wt %, based on a total weight of the negative electrode active material, and an amount of the soft carbon amorphous carbon was 36.2 wt %.

The negative electrode active material was used to manufacture a negative electrode, and this negative electrode was used with a lithium metal counter electrode and the electrolyte for a half-cell of Example 1 to fabricate a half-cell.

The negative electrode was also used with a LiNi_{0.88}Co_{0.1}Al_{0.1}O₂ positive electrode and the electrolyte for a full-cell according to Example 1 to fabricate a rechargeable lithium battery cell as a full cell.

### Example 5

A negative electrode active material was prepared in the same manner as in Example 3 except that the boron oxide was used in an amount of 6 wt %, based on a total weight of the silicon nanoparticles.

The prepared negative electrode active material included porous silicon secondary particles in which boron-doped silicon primary particles were agglomerated, soft carbon positioned inside pores of the porous silicon secondary particles, and a soft carbon coating layer on the porous silicon secondary particle surface.

An amount of boron included in the negative electrode active material was 2.1 wt %, based on a total weight of the negative electrode active material. The soft carbon coating layer had a thickness of 200 nm.

An amount of the silicon constituting the porous silicon secondary particles was 62 wt %, based on a total weight of the negative electrode active material, and an amount of the soft carbon amorphous carbon was 35.9 wt %.

The negative electrode active material was used to manufacture a negative electrode, and this negative electrode was used with a lithium metal counter electrode and the electrolyte for a half-cell of Example 1 to fabricate a half-cell.

The negative electrode was also used with a LiNi_{0.88}Co_{0.1}Al_{0.1}O₂ positive electrode and the electrolyte for a full-cell according to Example 1 to fabricate a rechargeable lithium battery cell as a full-cell.

### Comparative Example 1

An ethanol solvent and silicon particles with a particle size of several micrometers were mixed in a weight ratio of 8.5:1.5 and then, treated with a bead mill (Netzsch, Germany) to prepare silicon nano-dispersion. In the prepared silicon nano-dispersion, the average particle diameter (D50) of silicon nanoparticles (primary particles) was 90 nm, and the maximum particle diameter (Dmax) was 150 nm.

The silicon nano-dispersion was spray dried at 180° C. by using a spray dryer to prepare porous silicon secondary particles. The prepared porous silicon secondary particles were formed by agglomerating primary particles, which were silicon nanoparticles, and had a pore volume of 0.007 cm³/g.

The obtained porous silicon secondary particles and petroleum pitch were heat-treated at 950° C. for 2 hours under a N₂ atmosphere to prepare a heat treatment product. The porous silicon secondary particles: the petroleum-based pitch had a weight ratio of 63.3:36.7.

The prepared negative electrode active material included porous silicon secondary particles internally including pores, a soft carbon coating layer on the porous silicon secondary particle surface, and soft carbon positioned inside the pores. An amount of silicon constituting the porous silicon was 63.3 wt %, based on a total weight of the negative electrode active material, and an amount of the soft carbon amorphous carbon was 36.7 wt %.

The negative electrode active material was used to manufacture a negative electrode, and this negative electrode was used with a lithium metal counter electrode and the electrolyte for a half-cell according to Example 1 to fabricate a half-cell.

The negative electrode was also used with a LiNi_{0.88}Co_{0.1}Al_{0.1}O₂ positive electrode and the electrolyte for a full-cell according to Example 1 to fabricate a rechargeable lithium battery cell as a full-cell.

### Comparative Example 2

SiOₓ (x=1.1) and boron oxide (B₂O₃) were mixed in a weight ratio of 98:2 to prepare a mixture.

The mixture was heat-treated at 950° C. for 2 hours under a N₂ atmosphere to manufacture a negative electrode active material as a heat treatment product.

The prepared negative electrode active material included SiOₓ, boron doped on SiOₓ, and boron positioned on the surface of SiOₓ. An amount of boron included in the negative electrode active material was 0.7 wt %, based on a total weight of the total negative electrode active material.

The negative electrode active material was used to manufacture a negative electrode, and this negative electrode was used with a lithium metal counter electrode and the electrolyte for a half-cell according to Example 1 to fabricate a half-cell.

The negative electrode was also used with a LiNi_{0.88}Co_{0.1}Al_{0.1}O₂ positive electrode and the electrolyte for a full-cell of Example 1 to fabricate a rechargeable lithium battery cell as a full cell.

### Experimental Example 1: Cross-Sectional SIMS Analysis of Negative Electrode Active Material

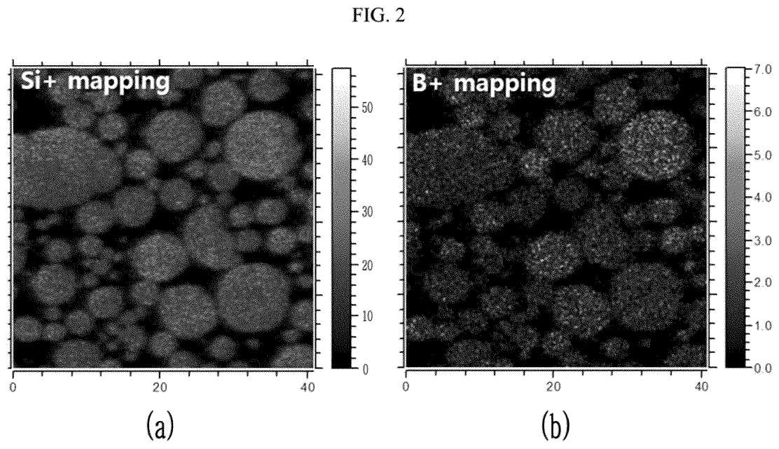

A SIMS (Secondary Ion Mass spectroscopy) analysis was performed on the cross-section of the negative electrode active material of Example 1. Among the results, a silicon (Si) element mapping analysis result was shown in (a) of FIG. 2. A boron element mapping analysis result in the same region as (a) of FIG. 2 is shown in (b) of FIG. 2. Referring to FIG. 2, boron was positioned inside the silicon primary particles.

### Experimental Example 2: Surface and Internal XPS (X-Ray Photoelectron Spectroscopy) Analysis of Negative Electrode Active Material

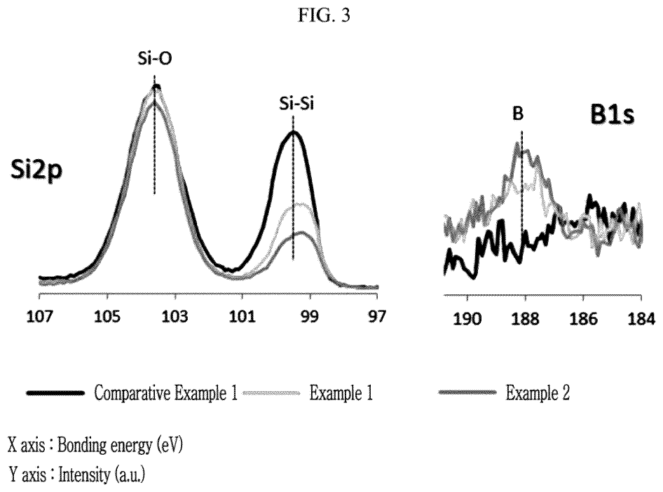

The negative electrode active materials of Examples 1 and 2 and Comparative Example 1 were analyzed in an X-ray photoelectron spectroscopy (XPS) method. The results are shown in FIG. 3. As shown in FIG. 3, Si and elemental boron were present inside the prepared negative electrode active material. As more boron oxide was used, a boron peak increased, but an Si—Si bond decreased.

### Experimental Example 3) X-Ray Diffraction Measurement

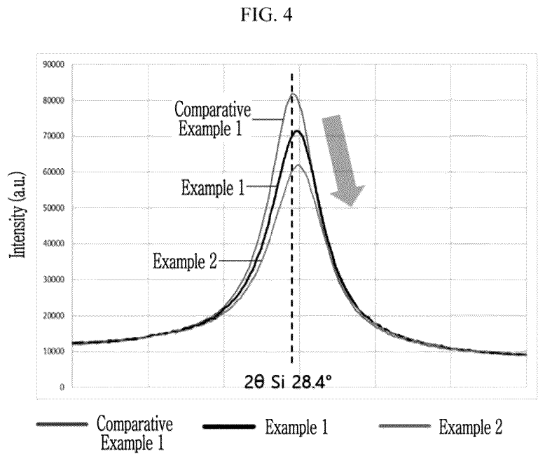

An X-ray diffraction peak analysis using CuKα rays was performed on the negative electrode active materials of Examples 1 and 2 and Comparative Example 1. The results are shown in FIG. 4. In FIG. 4, an x-axis was 20. As shown in FIG. 4, as more boron oxide was used, an Si peak showed smaller intensity but shifted toward larger 20. Referring to the results, boron was well doped inside the particles.

### Experimental Example 4) Cycle-Life Characteristics

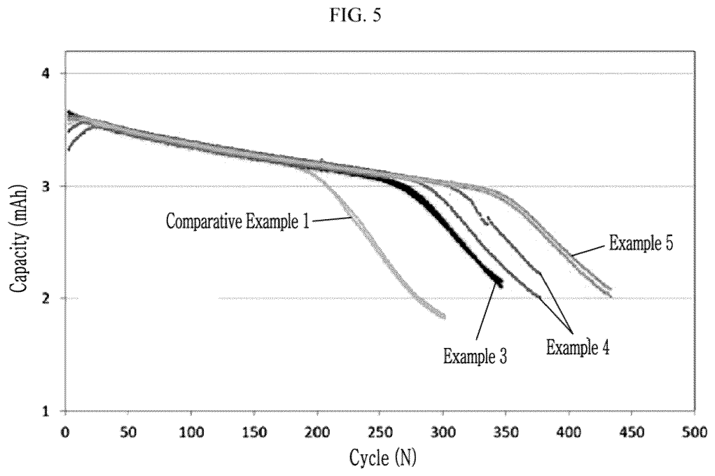

The rechargeable lithium battery cells of Examples 1 to 5 and Comparative Examples 1 and 2 were charged and discharged at room temperature (25° C.) 200 times under the following conditions to measure discharge capacity at each cycle. Among the results, the results of Comparative Example 1 and Examples 3 to 5 are shown in FIG. 5.

Charge: 1.0 C/cut-off: 4.0 V to 0.05 C

Discharge: 1.0 C/cut-off 2.5 V

As shown in FIG. 5, the cells of Examples 3 to 5 (including boron oxide)

exhibited excellent cycle-life characteristics and capacity retention rate, compared with the cell of Comparative Example 1.

A ratio of the 200^{th} discharge capacity to the 1^{st} discharge capacity was calculated. Among the results, the results of Comparative Examples 1 to 2 are shown as capacity retention rate in Table 1. A ratio of discharge capacity at each cycle to the 1^{st} discharge capacity was calculated to find out the number of cycles if the capacity ratio sharply dropped to less than 80%, which was shown as a cycle when cycle-life sharply decreased in Table 1.

TABLE 1

| | Capacity retention | Cycle when cycle-life |
|---|---|---|
| | ratio (%) | sharply decreased |
| Comparative | 86 | 210 |
| Example 1 | | |
| Comparative | 81 | 300 |
| Example 2 | | |

As shown in Table 1, Comparative Example 2 exhibited a sharply decreased cycle-life at the same cycles as or more cycles but much lower capacity retention rate than Comparative Example 1.

Referring to the results of FIG. 5 and Table 1, Comparative Example 1 exhibited very low cycle-life and capacity retention rate, compared with Examples 3 to 5, Comparative Example 2 exhibited lower capacity retention rate than Comparative Example 1, and Comparative Example 2 may be expected to exhibit significantly lower cycle-life characteristics than Examples 3 to 5.

One or more embodiments may provide a negative electrode active material that exhibits high efficiency, high capacity. and long cycle-life characteristics.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode active material, comprising:
porous silicon secondary particles in which boron-doped silicon primary particles are agglomerated; and
amorphous carbon.

2. The negative electrode active material as claimed in claim 1, wherein an amount of boron in the negative electrode active material is about 0.01 wt % to about 5 wt %, based on a total weight of the negative electrode active material.

3. The negative electrode active material as claimed in claim 1, wherein the amorphous carbon is between the boron-doped silicon primary particles or on a surface of the porous silicon secondary particles.

4. The negative electrode active material as claimed in claim 1, wherein a pore volume of the porous silicon secondary particles is about 0.001 cm³/g to about 0.01 cm³/g.

5. The negative electrode active material as claimed in claim 1, further comprising a boron material.

6. The negative electrode active material as claimed in claim 5, wherein the boron material comprises boron oxide, boric acid, MgB₂, boron, or a combination thereof.

7. The negative electrode active material as claimed in claim 6, wherein the boron material comprises boron oxide, boric acid, boron, or a combination thereof.

8. The negative electrode active material as claimed in claim 5, wherein the boron material is on a surface of the boron-doped silicon primary particles or on a surface of the porous silicon secondary particles.

9. The negative electrode active material as claimed in claim 1, wherein the amorphous carbon comprises soft carbon, hard carbon, a mesophase pitch carbonized product, sintered coke, or a combination thereof.

10. The negative electrode active material as claimed in claim 1, wherein an average particle diameter (D50) of the boron-doped silicon primary particles is about 10 nm to about 500 nm.

11. The negative electrode active material as claimed in claim 1, wherein an average particle diameter (D50) of the porous silicon secondary particles is about 5 μm to about 12 μm.

12. The negative electrode active material as claimed in claim 1, wherein:
the amorphous carbon is in the form of a coating layer, and
a thickness of the amorphous carbon coating layer is about 1 nm to about 2 μm.

13. A rechargeable lithium battery, comprising:
a negative electrode including the negative electrode active material as claimed in claim 1,
a positive electrode, and
an electrolyte.
